(19) United States
(12) Patent Application Publication
(10) Pub. No.: US 2011/0008126 A1
(43) Pub. Date: Jan. 13, 2011

(54) DEVICE FOR FASTENING PLASTIC PARTS TO A MOTOR VEHICLE BODY

(75) Inventor: Thorsten Schraer, Jetzendorf (DE)

Correspondence Address: CLARK HILL PLC, 150 NORTH MICHIGAN AVENUE, SUITE 2700, CHICAGO, IL, 60601, US

(73) Assignee: ACUMENT GMBH & CO. OHG, Neuwied (DE)

(21) Appl. No.: 12/673,638

(22) PCT Filed: Jul. 24, 2008
(86) PCT No.: PCT/DE08/01226

§ 371 Date: Apr. 26, 2010

(30) Foreign Application Priority Data
Aug. 16, 2007 (DE) 20 2007 011 491.5

(51) Int. Cl. F16B 39/24

(52) U.S. Cl. 411/108

(57) ABSTRACT

The invention relates to a device for fastening plastic parts (10) to a motor vehicle body (12), having an internal thread (14) which is formed on the body (12) and having a screw (16) which has an external thread (18) and which is provided with an oversized head (20), which screw (16) is inserted into the internal thread (14), wherein a cylindrical sleeve (22) is placed between the screw head (20) and the body (12), the inner diameter of which cylindrical sleeve (22) is significantly larger than the outer diameter of the external thread (18) of the screw (16), and wherein a cylindrical sleeve (24) is attached coaxially, by means of its inner edge which faces toward the body (12), to the outer edge, which faces away from the body (12), of the sleeve (22), the inner diameter of which cylindrical sleeve (24) forms a fit with the outer diameter of the sleeve (22), and which cylindrical sleeve (24) ends, at its body-side end, in an outwardly extending disk (26), the outer diameter of which corresponds approximately to the outer diameter of the screw head (20), wherein an opening (28) for receiving the device is provided in the plastic part (10), the inner diameter of which opening (28) is larger than the outer diameter of the sleeve (24) but smaller than the outer diameter of the flat washer or of the oversized screw head (20) and of the disk (26) which is attached to the sleeve (24).

The present invention relates to a device for fastening plastic parts to a motor vehicle body having an internal thread which is provided on the body of the motor vehicle and having a screw with an external thread inserted into the internal thread.

At the present time the tendency in the development of motor vehicles it to increasingly construct the bodies of a mixture of metal parts and plastic parts. Especially for the reason to decrease the weight it is aimed for to manufacture the fenders from plastic. When mounting such fenders of plastics on a body which apart from the fenders is consisting of metal the problem however is arising that the fender of plastics during the mounting at the metal body has to be fastened such that during the mounting it has to be possible to take care for manufacturing tolerances (e.g. gaps) to adjust the fender during the mounting in and against the driving direction (in the X-direction) as well as in the direction of the body or away from the body (in the Y-direction). Additionally, it has to be ensured that the differing thermal extension coefficients of metal and plastics can be compensated during the life of the motor vehicle. For this reason, the fender has to be mounted such that it can compensate a play upwardly and downwardly for compensating thermal deformations of the metal body which means in the Z-direction.

Presently, for this purpose in the motor vehicle industry a rather complicated steel element having several additional elements has to be used to fasten the fender at its point of fixation close to the bottom of the motor vehicle and in the vicinity of the front door of the motor vehicle at the height of the A-column wherein simultaneously a compensation of play with regard to the height, e.g. a compensation of play for thermal expansion in the Z-direction, has to be compensated.

It is therefore the task to be solved by the present invention to provide a device as simple as possible for fastening plastic parts, especially fenders, to a motor vehicle in which during the mounting an adjustment of the body distance between fender and door in the driving direction (the X-direction) and in the direction towards the body (in the Y-direction, i.e. sidewardly, becomes possible to achieve that the fender is positioned in parallel to the surface of the door and to make it possible that the necessary measurements of gaps between fender and door can be kept. Additionally, it should be possible that the fender can be fixed in this position. This all possibly should be done automatically by robots. Additionally, the fastening device according to the invention should enable a compensation of play upwardly or downwardly, respectively, i.e. in the Z-direction, to compensate the different thermal expansion between the metal body and the plastic fender.

According to the invention this task is solved by the features that in such a device for fastening plastic parts to a motor vehicle body, the screw is provided with an oversized head or a corresponding washer wherein between the head of the screw and the motor vehicle body a cylindrical sleeve is provided the inner diameter of which is significantly larger than the outer diameter of the external thread of the screw and wherein a cylindrical sleeve is attached coaxially by means of its inner edge which faces towards the interior, the diameter of which is forming a fit with the exterior diameter of the sleeve and which ends at its bodyside end in an outwardly extending disk the outer diameter of which, corresponds approximately to the outer diameter of the screw head or the washer wherein an opening for receiving the device is provided in the plastic part the inner diameter of which is larger than the outer diameter of the sleeve but smaller than the outer diameter of the washer or the oversized screw head and of the disc which is attached to the sleeve.

In this connection it is preferred that the sleeve before the mounting is connected by means of a thin edge with the sleeve which under a load in axial direction is fractured. In this way the sleeve and the cylindrical sleeve are connected with each other without the possibility of loss which is substantially simplificating the storing, handling and mounting.

Alternatively to the above the sleeve before the mounting can be connected with the other sleeve by gluing wherein the glued connection is performed in such a way that the glued connection under a load in axial direction of the sleeve is fractured. This solution is to be preferred, it the one sleeve and the other sleeve are separately manufactured.

Apart of that the sleeve already before the mounting can be by means of a press fit maintained on the other sleeve.

To provide for an adjustment of the fender towards the motor vehicle body or away from the same (in the Y-axes) and to hold this position and to secure the same it is preferred if the screw with the interior thread provided in the body is forming a clamping screw fixing lock.

Due to the simple kind of manufacture and the advantageous costs it is preferred to manufacture the cylindrical sleeve and the other sleeve from steel.

To premount the device according to the invention at the tender it is especially preferred to maintain the screw before the mounting by means of a star-shaped punched washer having a larger diameter than the sleeve within the sleeve said washer being attached to the end of the external thread facing away from the screw head outwardly of the sleeve, said washer having a larger diameter than the sleeve.

In this way the device according to the invention can be attached to the fender and can be used during the final mounting of the body together with the fender at the body which substantially is simplificating the handling and the storage.

Alternatively to the above the screw before the mounting can be maintained in the sleeve by means of a plastic ring or foam rubber ring injection moulded onto the end of the external thread facing away from the screw head and having a larger diameter than the sleeve. This, too, allows a pre-mounting at the fender before the final mounting of the fender to the body.

An especially cost-saving manufacture of the device according to the invention can be achieved if the cylindrical sleeve and the other sleeve together are manufactured from a blank my means of a cold-shaping procedure.

An especially cost-saving production of the device according to the invention is possible, too, if the cylindrical sleeve and the other sleeve are manufactured from plastics.

In this connection the manufacture can be simplified further by manufacturing the cylindrical sleeve and the other sleeve together in an injection moulding procedure as one injection-moulded member.

In the following the present invention is more detailedly described with reference to an exemplary embodiment shown in the drawings:

In the drawings shows:

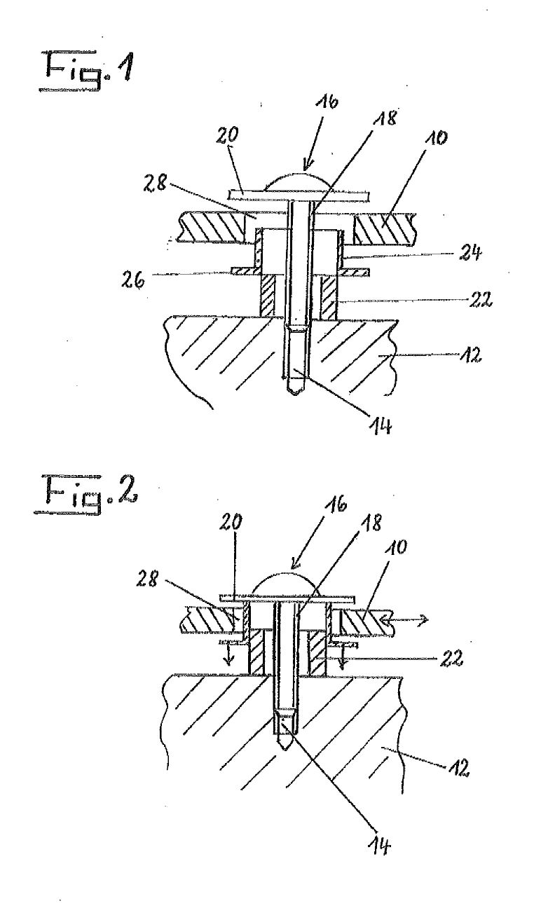

FIG. 1 a sectional few of a device according to the invention for fastening of plastic fenders to a motor vehicle body at the beginning of the mounting procedure: and

FIG. 2 a device according to FIG. 1 during the mounting procedure wherein by the arrows the different possibilities of play compensation are shown in the X-, Y-, and Z-direction.

FIG. 1 is showing the device according to the invention for fastening of plastics fenders to a motor vehicle body at the beginning of the mounting of the fender 10 to the body 12. For the purpose of fastening the fender 10 an interior thread 14 is provided in the body 12. In the representation of FIG. 1 the screwing in of the screw 16 into this interior thread 14 is just beginning. To this purpose the screw 16 is provided with an exterior thread 18. To hold the fender 10 the screw 16 in the present case is provided with an oversized head 20. Instead thereof a usual screw and additionally a washer of a suitable diameter can be provided, too.

This screw head or the washer, respectively, is holding the fender 10 after the mounting against forces which in the drawing are acting in the upward direction.

Between the fender 10 and the body 12 in this connection the decisive part of the device according to the invention is used. This part is a hollow cylindrical sleeve 22 being open on both ends wherein at the external edge of said sleeve facing away from the body a cylindrical sleeve 24 is provided preferably fixed by a thin edge of by gluing or by a pressure fit. This sleeve 24, too, is shaped as a hollow cylinder with open ends wherein the interior diameter of the sleeve 24 is slightly larger than the exterior diameter of the sleeve 22. The height of the sleeve 24 preferably is corresponding approximately to the height of the sleeve 22. On the side facing the body the sleeve 24 is ending towards the exterior in a disc 26 which in the mounted state is preventing a movement of the fender 10 with respect to the body 12 in the direction running downwardly in the drawing. The sleeve 24 and the sleeve 22 in this connection preferably are consisting of steel wherein a manufacturing process is especially preferred in which the sleeve and the other sleeve together are manufactured from one blank by means of a single cold shaping procedure. In this connection, manufacturing procedures are especially recommended as these already are known for the production of blind riveting nuts.

In case the screw before the mounting has to be secured at the device or in case one wants to attach the device before the mounting of the fender at the body secured against loss at the fender then it is recommended to hold the screw in the sleeve 22 by means of a washer punched in a star-shape and having a larger diameter compared with the sleeve 22 and being attached to the end of the exterior thread 18 externally of the sleeve 22 onto the exterior thread 18.

Alternatively to the above the screw, too, can be held in the sleeve 22 by means of a plastic ring or foam rubber moulded onto the exterior thread 18 at the end of the exterior thread 18 facing away from the screw head 20.

With reference to FIG. 2 now the course of events will have to be explained during the mounting of the device according to the invention and the possible compensation of play by the device according to the invention.

FIG. 2 is showing the state after a partly mounting. The screw 16 already to a large extent is screwed into the interior thread 14. The fender 10 is held between the oversized screw head 20 or a corresponding washer, respectively, and the disc 26 attached to the sleeve 24 with play wherein in the fender 10 an opening 28 is provided the interior diameter of which is remarkably larger than the exterior diameter of the sleeve 24 but smaller, however, than the exterior diameter of the disc 26 and of the oversized screw head 20 or a corresponding washer, respectively.

In this way the necessary play in the X- or Z-direction, respectively, is maintained as well between the fender 10 and the sleeve 24 as by the play between the exterior diameter 18 of the screw 16 and the distinctively larger interior diameter of the sleeve 22. The adjustment in Y-direction, i.e. in the direction of the body or away from the body, respectively, by these means can be adjusted by how far the screw 16 is turned into the interior thread 14. As soon as namely the screw 16 has contacted the sleeve 24 and thereafter is turned further the thin edge between the sleeve 24 and the sleeve 22 is breaking or a glued connection, respectively, provided at this location. Alternatively the sleeve 24 can be held on the sleeve 22 by means of a press fit. The sleeve 24 during the further tightening of the screw 16 thereafter is pushed over the exterior surface of the sleeve 22. This procedure is ended as soon as the screwing-in of the screw 16 is ended. In this way the fender is adjusted in the Y-direction.

In the state according to FIG. 1 an adjustment forwardly and backwardly, too, i.e. in the X-direction, was possible to correctly adjust the dimension of the gap between the fender and the door. This play occurred between the exterior diameter of the exterior thread 18 and the significantly larger chosen interior diameter of the sleeve 22. If, however, the screw 16 is sufficiently tightened, then the pretension transferred via the sleeve 24 and the sleeve 22 to the body 12 is sufficient to maintain the device according to the invention in the adjusted position. In case the opening 28 is an elongated opening in a suitable direction, then, however, the necessary play in the Z-direction for compensating different thermal expansion can be maintained between the exterior diameter of the sleeve 24 and the interior diameter of the opening 28 or elongated opening 20 in the fender 10.

A special advantage of the present invention is resulting in the fact that only one element, namely the combination of sleeve 22 and sleeve 24 which possibly by known manufacturing procedures by moans of a single cold shaping procedure can be manufactured from a single blank is necessary that the corresponding adjustment and fastening by means of merely one mounting step, namely the tightening of the screw 10, is achieved. Additionally, the device according to the invention can be manufactured extremely cost-saving due to the fact that it can be produced, as already stated, by means of a single cold shaping procedure from one blank.

Corresponding manufacturing procedures, for example, are known from the production of blind rivet nuts. For this purpose, usually, a undercut forging tool or an additional cutting procedure as used in connection with screws having a cone-shaped tip is used. Additionally, only a screw with an oversized head or a standard screw with a suitable washer is necessary. Additionally, the fastening device according to the invention can be premounted on the fender by inserting the screw into the combination of sleeve and additional sleeve and holding the screw in this place by means of a star-shaped punched washer attached thereon having a larger diameter than the sleeve 22 or by means of a plastic ring injected on a suitable position of the exterior thread. Corresponding star-shaped punched washers already are obtainable on the market under the designation “Starlock®”. The same is true for the co-injected plastic rings which are known under the designation “Nystop®”.

Therefore by the present invention the following advantages are obtained:

It is only one element necessary for compensating tolerances for ensuring the play for compensating thermal tensions and for fastening the fender. The solution according to invention therefore is significantly cheaper, especially due to the fact that a member is necessary which merely is produced by means of a known cold-shaping procedure or injection moulding.

Preferably, the combination of sleeve 22 and sleeve 24 can be manufactured from plastics. In this connection, for the simplification of the production it is especially preferred, if the sleeve and the other sleeve in one injection moulding procedure are produced as a single injection-moulded member.

The fastening of the fender at the body, too, significantly is facilitated by the present invention. The fastening, namely, can be done by a single mounting step, namely the tightening of the screw wherein the adjustment in the Y-direction is done by the fact how far the screw is tightened.

Additionally, the device according to the invention can be pre-mounted at the fender which significantly is facilitating the storing and handling.

Finally it has to be stated that my means of the present invention by use of a single element, namely the unitarily producible combination of bushing 22 and sleeve 24 the adjustment of the fastening and the compensation of thermal play are possible.

1. A device for fastening plastic parts (10) to a motor vehicle body having an internal thread (14) which is provided at the body (12) and a screw (16) which has an external thread (18) which is inserted into the internal thread (14), characterized in that the screw (16) is provided with an oversized head (20) or a corresponding washer wherein between the screw head (20) and the body (12) a cylindrical sleeve (22) is provided the interior diameter of which is significantly larger than the exterior diameter of the external thread (18) of the screw (16) and wherein a cylindrical sleeve (24) is attached coaxially by means of its inner edge with faces towards the body (12), to the outer edge which faces away from the body (12), of the sleeve (22) the inner diameter of the cylindrical sleeve (24) forms a fit with the outer diameter of the sleeve (22) and which cylindrical sleeve (24) ends at its body-side end in an outwardly extending disc (26) the outer diameter of which corresponds approximately to the outer diameter of the screw head (20) or the washer, respectively, wherein an opening (28) for receiving the device is provided in the plastic part (10), the inner diameter of which is larger than the outer diameter of the sleeve (24) but smaller than the outer diameter of the washer or the oversized screw head (20), respectively, and of the disc (26) which is attached with the sleeve (24).

2. Device according to claim 1, characterized in that the sleeve (24) before the mounting by means of an edge is connected with the sleeve (22) which under a load in an axial direction of the sleeve (24) is breaking.

3. Device according to claim 1, characterized in that the sleeve (24) before the mounting is connected with a sleeve (22) by gluing wherein the glued connection is designed such that the glued connection under a load in an axial direction of the sleeve (24) is breaking.

4. Device according to claim 1, characterized in that the sleeve (24) already before the mounting is held on the sleeve (22) by a pressure fit.

5. Device according to any of the claims 1 to 4 characterized in that the screw (16) together with the interior thread (14) provided at the body (12) is forming a clamping screw securing safety.

6. Device according to any of the claims 1 to 5 characterized in that the sleeve (22) and the sleeve (24) are consisting of steel.

7. Device according to any of the claims 1 to 6 characterized in that the screw (16) before the mounting is held within the sleeve (22) by means of a star-shaped punched washer having a larger diameter than the sleeve (22) and attached to the end of the exterior thread (18) facing away from the screw head externally of the sleeve (22).

8. Device according to any of the claims 1 to 5 characterized in that the screw (16) before the mounting is held in the sleeve (22) by means of a plastic ring injection moulded onto the exterior thread (18) or a foam rubber both having a larger diameter than the sleeve (22) and being attached to the end of the exterior thread (18) facing away from the screw head (20).

9. Device according to any of the claims 1 to 7 characterized in that the sleeve (22) and the sleeve (24) by means of a cold-shaping procedure jointly are produced from one blank.

10. Device according to any of the claims 1 to 5 characterized in that the sleeve (22) and the sleeve (24) are consisting of plastics.

11. Device according to claim 10 characterized in that the sleeve (22) and the sleeve (24) are produced by means of an injection moulding procedure as one injection-moulded member.
